(19) United States
(12) Patent Application Publication
(10) Pub. No.: US 2011/0243550 A1
(43) Pub. Date: Oct. 6, 2011

(54) SYSTEM AND METHOD FOR HIGH-SPEED SHUTTERING

(76) Inventor: Laurence M. Flath, Moss Beach, CA (US)

(21) Appl. No.: 12/752,871

(22) Filed: Apr. 1, 2010

(51) Int. Cl. G03B 9/14; G02B 26/02

(52) U.S. Cl. 396/502; 359/235

(57) ABSTRACT

A shutter system may be used as part of an imaging device, such as a CMOS imaging device. The shutter system comprises a support structure, and first and second shutter members are rotatably mounted to the support structure so as to have respective first and second axes of rotation. The first and second shutter members have respective first and second shutter apertures defined therethrough, with the first shutter apertures having a first circular orbit about the first axis of rotation and the second shutter aperture having a second circular orbit about the second axis of rotation. The first and second shutter members at least partially overlap, and the first circular orbit and the second shutter circular orbit also at least partially overlap, so that rotation of the first and second shutter members at different frequencies cycles the first and second shutter apertures into and out of registration with each other.

### FIELD OF THE INVENTION

The present invention relates to shutter systems and methods, and more particularly to systems and methods for high-speed shuttering of rolling-mode integration focal plane arrays.

### BACKGROUND OF THE INVENTION

Complementary metal-oxide-semiconductor (CMOS) sensors are becoming a popular alternative to charge-coupled devices (CCDs) as electronic imaging devices due to their relatively low cost, low power consumption, and overall reduced system size and complexity. Also, the CMOS process allows for integration of digital circuitry (including image processing functions) on the same piece of silicon as the imaging circuitry. CMOS focal plane arrays, unlike CCDs, take advantage of current integrated circuit fabrication processes to provide much smaller pixel pitches than average CCDs.

The chart below sets out a comparison between the characteristics of a CCD focal plane array and a CMOS focal plane array.

| | CCD | CMOS |
|---|---|---|
| Noise | Lower | Higher |
| Structure | Simple | ≧2 transistors per pixel |
| Fill-Factor | High, depending on readout-type | Low, due to per-pixel |
| | (up to nearly 100%) | components |
| Fabrication | Specialized, not compatible with | Compatible with standard |
| | standard digital logic, usually | digital logic, uses current |
| | past-generation | design rules |
| | design rules | |
| System | Require numerous external | High-level of system |
| Complexity | analog biases, clocks, and | integration, including |
| | conversion | ADC and image |
| | | processing. |
| | | Power-in, data-out |

Unfortunately, CMOS sensors have several drawbacks that limit their use for certain applications. For example, less sophisticated (and hence less expensive) CMOS focal plane arrays use rolling-mode integration. Such focal plane arrays are generally unable to capture imagery in a single snapshot with variable exposure times.

### SUMMARY OF THE INVENTION

A dual-shutter system for a rolling-mode integration image sensor comprises two rotating shutter members each having a shutter aperture, with rotation of the shutter members carrying the shutter apertures past a system aperture position that is in registration with the image sensor while moving the shutter members into and out of registration with each other. Radiation can only reach the image sensor when the shutter apertures are in registration with each other and are in further registration with the system aperture position and hence also in registration with the image sensor. This “gates” the light reaching the image sensor, allowing a rolling-mode integration imaging device to effectively operate in a snap-shot mode.

In one aspect, the present invention is directed to a shutter system for a rolling-mode integration imaging device. The shutter system comprises a support structure and first and second shutter members rotatably mounted to the support structure so as to have respective first and second axes of rotation. The first and second shutter members have respective first and second shutter apertures defined therethrough, which have respective first and second circular orbits about the first and second axes of rotation. The first and second shutter members at least partially overlap each other, and the first and second circular orbits of the shutter apertures also at least partially overlap so that rotation of the first shutter member and second shutter member at different frequencies cycles the first shutter aperture and the second shutter aperture into and out of registration with each other.

The shutter system may further comprise at least one actuator drivingly coupled to the first shutter member and the second shutter member to rotate the first shutter member and the second shutter member relative to the support structure. A single actuator may be drivingly coupled to both the first shutter member and the second shutter member, or a first actuator may be drivingly coupled to the first shutter member and a second actuator may be drivingly coupled to the second shutter member.

The shutter members may be disc-shaped shutters rotatably mounted to the support structure at their respective centers, and the shutter apertures may be respective truncated sector-shaped gaps in the first shutter member and the second shutter member. Optically clear material may extend across at least one of the first shutter aperture and the second shutter aperture.

In one embodiment, the first axis of rotation and the second axis of rotation are co-located so that the first shutter member and the second shutter member are rotatable about a single, common axis of rotation. In another embodiment, the first axis of rotation and the second axis of rotation are spaced from each other.

In another aspect, the present invention is directed to a rolling-mode integration imaging system. The imaging system comprises a rolling-mode integration focal plane array, and a shutter system as described above. The focal plane array is carried by the support structure, and a controller is coupled to the at least one actuator to control rotation of the shutter members so that rotation of the first shutter member and the second shutter member at different frequencies cycles the first shutter aperture and the second shutter aperture into and out of registration with each other in further registration with the focal plane array. The focal plane array may be a CMOS focal plane array.

In a further aspect, the present invention is directed to a method for operating a rolling-mode integration imaging device. The method comprises rotating first and second overlapping shutter members at different rotational frequencies, with the first and second shutter members having respective first and second shutter apertures defined therethough, so that radiation is permitted to reach an image sensor of the imaging device only when the first and second shutter apertures are in registration with each other in further registration with a focal plane array of the imaging device. The difference between the rotational frequency of the first shutter member and the rotational frequency of the second shutter member is selected according to a desired frame rate for the imaging device.

### BRIEF DESCRIPTION OF THE DRAWING FIGURES

In order that the subject matter may be readily understood, embodiments are illustrated by way of examples in the accompanying drawings, in which:

FIG. 1A is a top view of a first exemplary embodiment of a shutter system according to an aspect of the present invention;

FIG. 1B is a front view of the shutter system of FIG. 1A;

FIG. 1C is a side view of the shutter system of FIG. 1A;

FIG. 2A is a top view of a second exemplary embodiment of a shutter system according to an aspect of the present invention;

FIG. 2B is a front view of the shutter system of FIG. 2A;

FIG. 2C is a side view of the shutter system of FIG. 2A;

FIG. 3A is a top view of a third exemplary embodiment of a shutter system according to an aspect of the present invention;

FIG. 3B is a front view of the shutter system of FIG. 3A;

FIG. 3C is a side view of the shutter system of FIG. 3A;

FIG. 4A is a top view of a first exemplary imaging system according to an aspect of the present invention;

FIG. 4B is a front view of the imaging system of FIG. 4A;

FIG. 4C is a side view of the imaging system of FIG. 4A;

FIG. 5A is a top view of a second exemplary imaging system according to an aspect of the present invention;

FIG. 5B is a front view of the imaging system of FIG. 5A;

FIG. 5C is a side view of the imaging system of FIG. 5A;

FIGS. 6A to 6F show various exemplary shutter members, according to aspects of the present invention;

FIGS. 7A to 7C show three sequential stages of rotation of a pair of shutter members rotating in opposite rotational directions at a first set of different rotational frequencies, according to an aspect of the present invention;

FIGS. 8A to 8C show three sequential stages of rotation of a pair of shutter members rotating in opposite rotational directions at a second set of different rotational frequencies, according to an aspect of the present invention;

FIGS. 9A to 9C show three sequential stages of rotation of a pair of shutter members rotating in the same rotational direction at different rotational frequencies, according to an aspect of the present invention; and

FIG. 10 is a top view of a third exemplary imaging system according to an aspect of the present invention.

### DETAILED DESCRIPTION

The term “focal plane array”, as used herein, refers to a sensor that is sensitive to optical radiation and which is spatially discrete so as to be capable of forming an image, and is not limited to CMOS devices. As used herein, the term “rolling-mode integration” as applied to an image sensor refers to a situation in which all of the photodetectors on the focal plane array are essentially integrating, that is, recording received light, all of the time. Not all CMOS devices operate with rolling-mode-integration, and CMOS or other imaging devices that do not use rolling-mode integration are not appropriate for the systems and methods of the present invention. The present invention is intended for use with rolling-mode integration image sensors, that is, image sensors for which the detection process is active all of the time. As such, the term “image sensor” is not intended to be limited to electronic or digital image sensors, and may also include, for example, conventional film. As such, a rolling-mode integration imaging device may be, for example, a CMOS camera system or a conventional film camera. In the context of a conventional camera, the portion of film being exposed may be considered to fall within the scope of the term “focal plane array”.

For a rolling-mode focal plane array to capture instantaneous (i.e. “snap-shot”) images, some external mechanism is required. Ideally, an electronic shutter could be employed. Unfortunately, such devices (e.g. normal or ferro-electric LCDs) typically suffer from two disadvantages: at least one half of all incoming light is lost, which exacerbates the comparatively poor low-light performance of CMOS imaging devices, and the extinction-ratio is rarely better than 1000:1.

This leaves mechanical shutters as the primary method for controlling the light input to the focal plane array. Several mechanisms exist to provide high-speed shuttering. Familiar examples are the moving slot used in film and digital SLR cameras, and the leaved-iris used in medium/large format camera lenses; both of these work well for still cameras, but will eventually fail mechanically when used repetitively on motion video.

High-end film movie cameras shutter light via a wheel rotating at the film's frame rate with a variable aperture width specified in degrees; typical ranges are 10-180°, resulting in 1.16-13.89 ms exposure. The length of the exposure is approximately t_{frame}×θ/π, where t_{frame} is the frame rate.

It is difficult for such single-wheel shutter systems to provide controlled exposures at the low-end (e.g. the difference between 1-2 ms for a 1 Hz frame rate represents an aperture width difference of 0.36°, which would be about 300 μm on a 100 mm diameter wheel).

According to an aspect of the present invention, a dual-shutter system is provided which comprises two rotating shutter members, each having a shutter aperture. Rotation of the shutter members will repeatedly move the shutter apertures past a system aperture position that is in registration with the image sensor while also moving the shutter members into and out of registration with each other. Radiation can pass through the shutter members and reach the image sensor only when the shutter apertures are in registration with each other at the system aperture position.

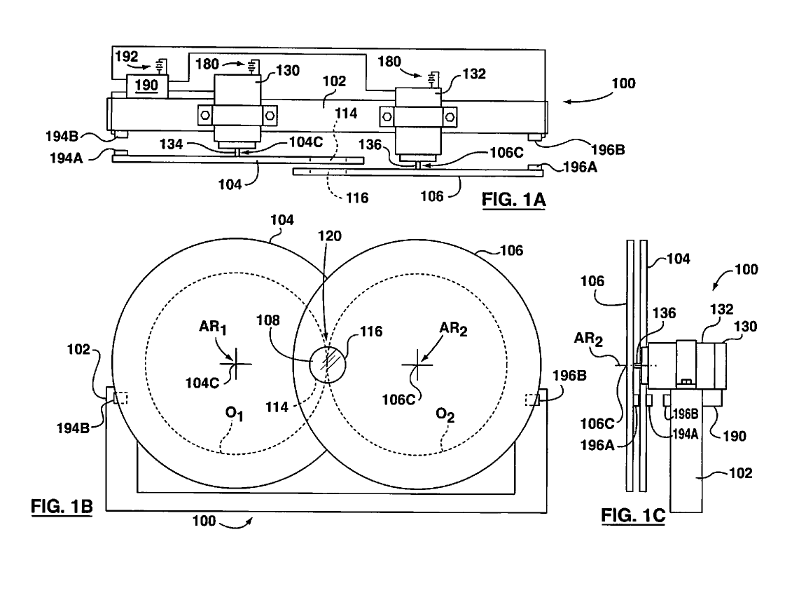

Referring now to FIGS. 1A through 1C, an exemplary shutter system for an imaging device according to an aspect of the present invention is shown generally at 100. The shutter system 100 comprises a support structure 102 and first and second shutter members 104 and 106, respectively, which, in the illustrated embodiment, are disc-shaped (e.g. wheels) and are rotatably mounted to the support structure 102 at their respective centers 104C, 106C so as to have respective first and second axes of rotation AR₁ and AR₂ (FIG. 1B). In the exemplary shutter system 100, the first axis of rotation AR₁ and the second axis of rotation AR₂ are spaced from each other.

The first and second shutter members 104, 106 have respective first and second shutter apertures 114, 116 defined therethrough. In the illustrated embodiment, the first and second shutter apertures 114, 116 are circular. Optically clear material 108 extends across the first shutter aperture 104 and the second shutter aperture 106; optionally the optically clear material 108 may be omitted. The optically clear material 108 is “optically clear” in the sense that it does not distort radiation that it permits to pass through the respective aperture 104, 106; the optically clear material 108 may be truly transparent and thus permit virtually all radiation to pass through the apertures 104, 106, or may provide suitable spectral and/or polarization filtering. Optically clear material may extend across one or both of the first shutter aperture 104 and the second shutter aperture 106 to provide desired optical effects during exposure of the image sensor (not shown in FIGS. 1A to 1C). Because the first and second shutter members 104, 106 are rotatably mounted to the support structure 102, the first shutter aperture 114 has a first circular orbit O₁ about the first axis of rotation AR₁ and the second shutter aperture 116 has a second circular orbit O₂ about the second axis of rotation AR₂.

The first and second shutter members 104, 106 are mounted to the support structure 102 so that they partially overlap each other and, as can be seen, the first circular orbit O₁ and the second circular orbit O₂ partially overlap each other. In the particular exemplary shutter system 100 shown in FIGS. 1A to 1C, the position where the respective circular orbits O₁ and O₂ overlap defines a system aperture position 120. The phases, that is, the rotational positions, of the first shutter aperture 114 and the second shutter aperture 116 are selected so that rotation of the first shutter member 104 and the second shutter member 106 at different frequencies will cycle the first shutter aperture 114 and the second shutter aperture 116 into and out of registration with each other at the system aperture position 120. The system aperture position is in registration with the image sensor (not shown in FIGS. 1A to 1C) so that when the first shutter aperture 114 and the second shutter aperture 116 are in registration with each other at the system aperture position 120, radiation (e.g. light) can pass through the shutter members 104, 106 to reach the image sensor. In other words, when the first shutter aperture 114 and the second shutter aperture 116 are in registration with each other they are also in registration with the image sensor.

When incorporated into an imaging device, such as a CMOS imaging device, one or more actuators, such as motors of sufficient precision, are drivingly coupled to the first shutter member 104 and the second shutter member 106 to rotate the first shutter member 104 and the second shutter member 106 relative to the support structure 102.

In the shutter system 100 shown in FIGS. 1A to 1C, a first actuator in the form of a first motor 130 is drivingly coupled to the first shutter member 104, and a second actuator in the form of a second motor 132 is drivingly coupled to the second shutter member 106. In particular, the first and second motors 130, 132 are carried by the support structure 102, and the first and second shutter members 104, 106 are mounted to the respective drive shafts 134, 136 of the first and second motors 130, 132 to achieve rotatable mounting of the first and second shutter members 104, 106 to the support structure 102; i.e. the motors 130, 132 may be considered to form part of the support structure 102. In operation, each of the motors 130, 132 are of course coupled to a suitable power source 180 as shown schematically in FIG. 1A.

As also shown in FIG. 1A, a controller 190 is coupled to the motors 130, 132 to control rotation of the motors 130, 132, that is, the motors 130, 132 are responsive to the controller 190. The controller 190 is coupled to a power source 192. Each of the shutter members 104, 106 has one or more respective phase indicators 194A, 196A, which may be, for example, a magnetic or visible marking, and the support structure 102 carries corresponding phase detectors 194B, 196B. The phase detectors 194B, 196B are sensors which detect the corresponding phase indicators 194A, 196A and send signals to the controller 190 representing the phase of the shutter members 104, 106. This enables the controller 190 to determine the phase, that is, the rotational position, of the shutter members 104, 106 and thereby control relative rotations of the shutter members 104, 106 by sending control signals to the motors 130, 132.

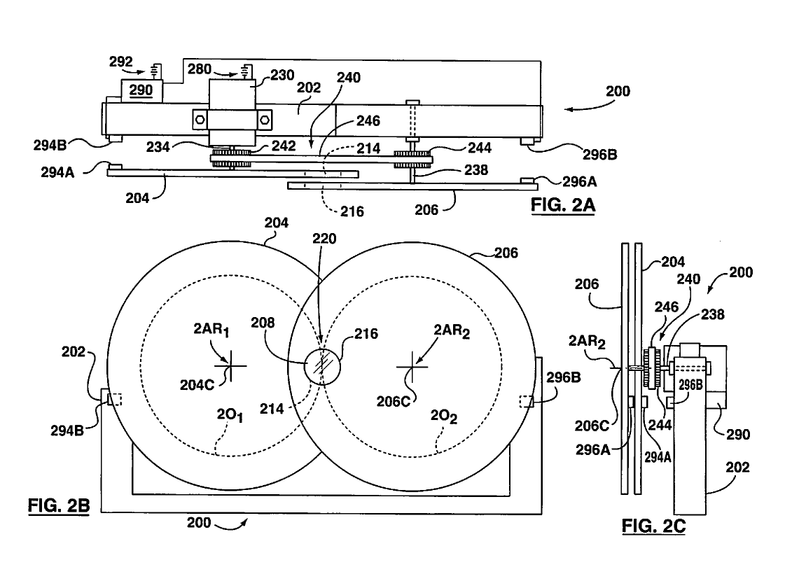

FIGS. 2A to 2C illustrate schematically a second embodiment of a shutter system according to an aspect of the present invention, which is denoted generally by the reference numeral 200. The second embodiment 200 is identical to the first embodiment except that a single actuator is drivingly coupled to both the first shutter member and the second shutter member. Accordingly, elements corresponding to elements in the first embodiment 100 are denoted by identical reference numerals, except beginning with “2” instead of “1”, so that the first shutter member is denoted by the reference 204, the second shutter member by the reference 206, and so on. The axes of rotation of the shutter members 204, 206 are denoted by 2AR₁ and 2AR₂, respectively, and the circular orbits of the shutter apertures are denoted by 2O₁ and 2O₂.

In the second embodiment 200, a single actuator in the form of a motor 230 carried by the support structure 202 drives both the first shutter member 204 and the second shutter member 206. The first shutter member 204 is mounted to the drive shaft 234 of the motor 230, and the second shutter member 206 is mounted to a driven shaft 238 carried by the support structure 202. The motor 230 is drivingly coupled to the second shutter member 206 by way of a transmission assembly 240 comprising a first gear 242 on the drive shaft 234 of the motor 230, a second gear 244 on the driven shaft 238, and a gear belt 246 mounted on the first and second gears 242, 244 to transmit rotation from the first gear 242 to the second gear 244. The sizes of the first and second gears 242, 244 are selected according to the desired rotational frequency of the second shutter member 206 in view of the rotational frequency of the first shutter member 204. The transmission assembly 240 shown in FIGS. 2A to 2C is exemplary only, and where a single actuator is to drive both the first and second shutter members, any suitable transmission assembly may be used so long as it provides sufficient precision to maintain the required differences in rotational frequencies.

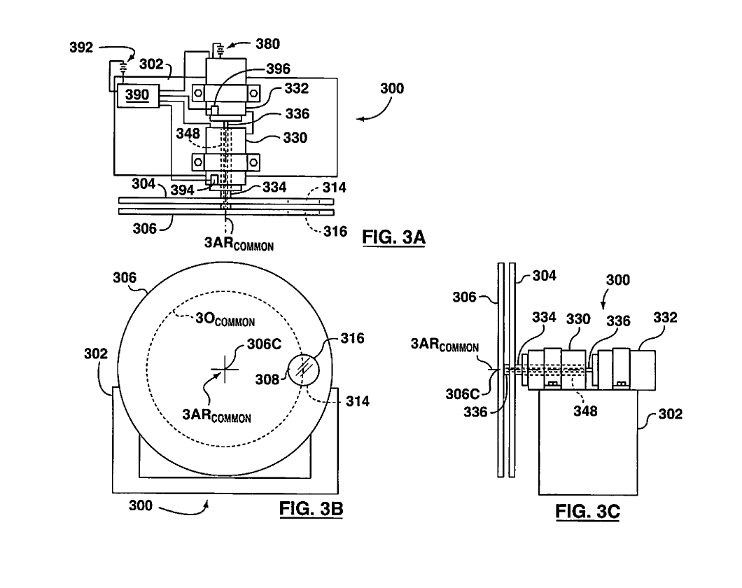

Reference is now made to FIGS. 3A to 3C, which illustrate schematically a third embodiment of a shutter system according to an aspect of the present invention, denoted generally by the reference numeral 300. As before, corresponding elements are denoted with corresponding reference numerals, but beginning with “3” instead of “2” or “1”. The third embodiment 300 is similar to the first embodiment 100, except that instead of the first and second axes of rotation AR₁ and AR₂ being spaced from each other as in the first and second embodiments 100, 200, in the third embodiment 300 the first axis of rotation and the second axis of rotation are co-located so that the first shutter member 304 and the second shutter member 306 are rotatable about a single, common axis of rotation 3AR_{COMMON}. The disc-shaped shutter members 304, 306 are the same size, and the shutter apertures 314, 316 are also the same size and are positioned at the same distance from the center 304C, 306C of their respective shutter member 304, 306. As such, the orbits of the first shutter aperture 314 and the second shutter aperture 316 completely overlap so that the first and second shutter apertures 314, 316 have a common orbit 3O_{COMMON}. As such, a system aperture position may be arbitrarily selected at any point on the common orbit 3O_{COMMON}.

A first motor 330 is drivingly coupled to the first shutter member 304 and a second motor 332 is drivingly coupled to the second shutter member 306. In particular, the first motor 330 has a first drive shaft 334 which carries the first shutter member 304 and the second motor 332 has a second drive shaft 336 which carries the second shutter member 306. The first and second drive shafts 334, 336 are coaxial with each other and with the common axis of rotation 3AR_{COMMON}, with the second drive shaft 336 rotatably nested inside the first drive shaft 334. The first drive shaft 334 has a larger diameter than the second drive shaft 336, and the first motor 330 has a central passageway 348, including an axial bore through the first drive shaft 334, through which the second drive shaft 336 extends and in which the second drive shaft 336 can rotate freely and independently of the first drive shaft 334. For example, the second drive shaft 336 may be supported inside the first drive shaft 334 by lubricated bearings. Thus, the first motor 330 can rotate the first shutter member 304 independently of the second motor 332 and the second shutter member 306, and the second motor 332 can rotate the second shutter member 306 independently of the first motor 330 and the first shutter member 304.

In the third embodiment 300 of a shutter system shown in FIGS. 3A to 3C, because the first shutter member 304 and the second shutter member 306 completely overlap, the use of external phase indicators and phase detectors would pose practical implementation difficulties. As such, in the third embodiment 300, the phase of the respective shutter members 304, 306 is detected indirectly, by way of phase detectors 394, 396 which are internal components of the respective motors 330, 332. The internal phase detectors 394, 396 detect the position of the respective drive shafts 334, 336, which, so long as the shutter members 304, 306 are mounted to the drive shafts 334, 336 with known orientation and sufficient precision, serves as an effective proxy for the phase (rotational position) of the shutter members 304, 306.

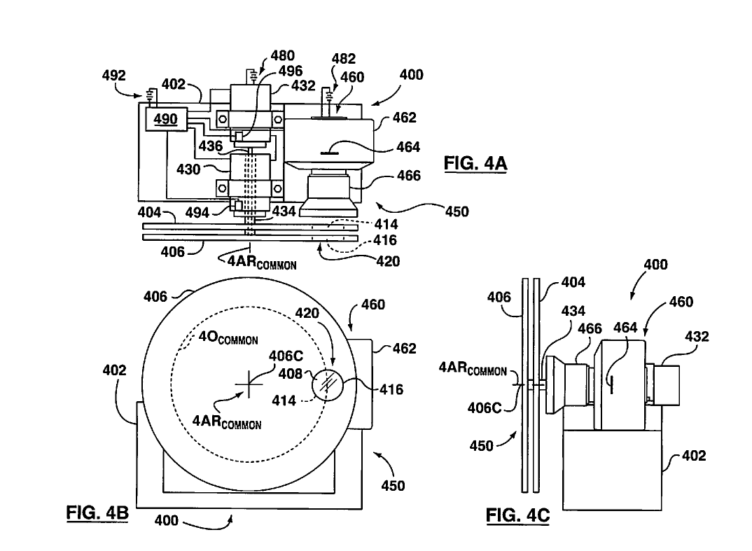

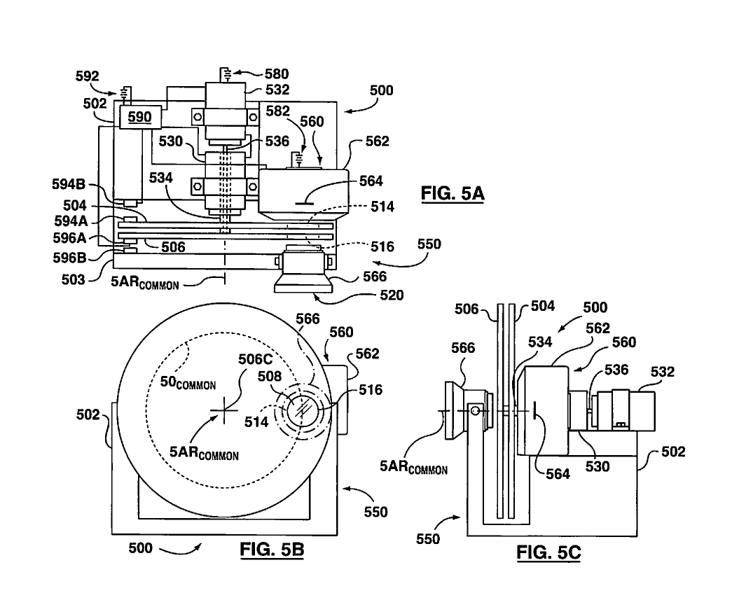

Reference will shortly be made to FIGS. 4A to 4C and 5A to 5C which show, respectively, first and second embodiments of a CMOS imaging device incorporating a CMOS focal plane array together with a dual-shutter system according to aspects of the present invention. In each case, the CMOS focal plane array is secured to the support structure and is in registration with the system aperture position so that the CMOS focal plane array will only receive radiation, such as visible light, when the first and second shutter apertures are simultaneously in registration with the system aperture position and hence with the focal plane array. As such, the phases of the shutter members must be selected so that the shutter apertures will be in registration with one another when they are in registration with the optical path to the CMOS focal plane array. Preferably, as shown in the illustrated embodiments, the system aperture position is near the system stop of the imaging device, that is, near the physical surface which allows light to pass but limits the diametric size of any optical ray bundle allowed into the optical system. A system stop is typically, but not necessarily, circular.

FIGS. 4A to 4C show a schematic representation of a first embodiment 450 of a CMOS imaging device incorporating a coaxial shutter system 400 similar to that shown in FIGS. 3A to 3C. Accordingly, corresponding reference numerals are used to refer to corresponding elements, only beginning with “4” instead of “3”. A CMOS camera 460 comprising a housing 462, CMOS focal plane array 464 and lens assembly 466 is carried by the support structure 402, with the focal plane array 464 and lens assembly 466 in registration with the system aperture position 420. In the first embodiment 450, the lens assembly 466 is disposed between the shutter members 404, 406 and the focal plane array 464, and the phase detectors are internal components of the respective motors 430, 432. A power source 482 is coupled to the CMOS camera 460, and the controller 490 is also coupled to the CMOS camera 460 so that it can synchronize rotation of the shutter members 404, 406 with the imaging operations of the CMOS camera 460.

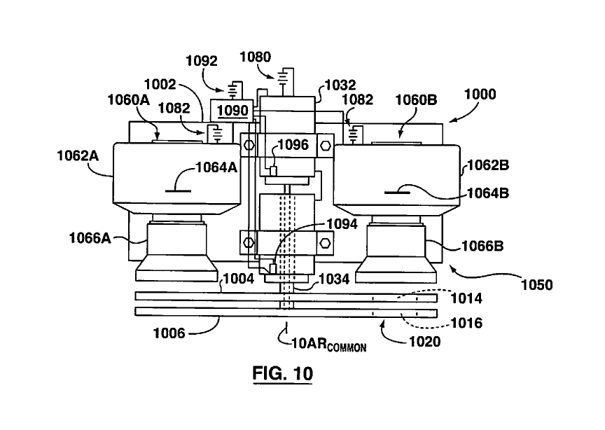

FIGS. 5A to 5C show a schematic representation of a second embodiment 550 of a CMOS imaging system which is similar to the first embodiment 450, and hence for which corresponding reference numerals are used to refer to corresponding elements, only beginning with “5” instead of “4”. In the second embodiment 550, the shutter members 504, 506 are disposed between the lens assembly 566 and the focal plane array 564. In this second embodiment 550, a first phase indicator 594A is disposed on the inner surface of the first shutter member 504, with the corresponding phase detector 594B carried by the main portion of the support structure 500, and a second phase indicator 596A is disposed on the outer surface of the second shutter member 506, with the corresponding phase detector 596B carried by the forward portion 503 of the support structure 500, which also carries the lens assembly 566.

Where a coaxial shutter system, such as the shutter systems 300, 400, 500 shown in FIGS. 3A to 3C, 4A to 4C and 5A to 5C, is used, more than one imaging device can be gated by the same shutter system. For example, FIG. 10 shows a third exemplary embodiment 1050 of a CMOS imaging system according to an aspect of the present invention. The third embodiment 1050 is similar to the first embodiment 450, except that it has two CMOS cameras 1060A and 1060B, each of which is gated by the same shutter system 1000. Corresponding reference numerals are used to refer to corresponding elements, only beginning with “10” instead of “4”.

The lens assemblies 466, 566, 1066A, 1066B shown in the Figure are not necessarily a single lens, but may be any suitable combination of optical elements.

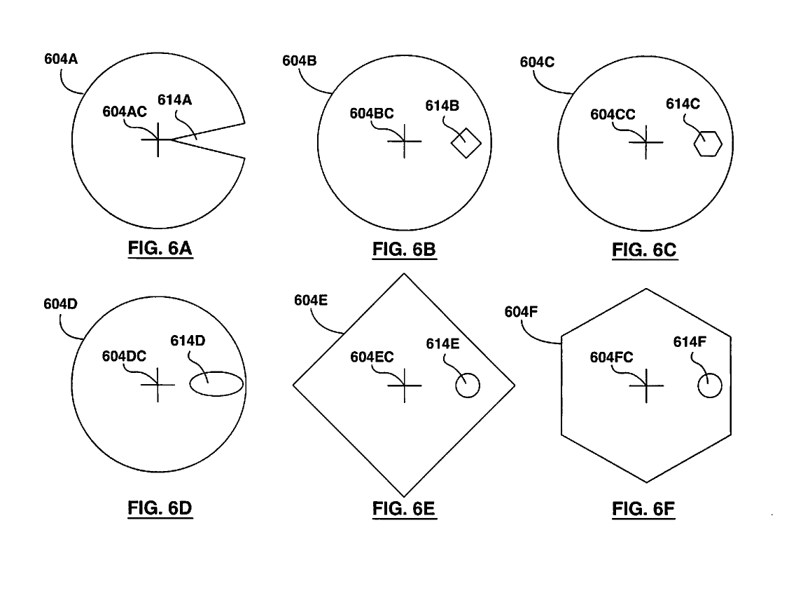

The time history of radiation (e.g. light energy) passing through the shutter apertures is the integration of the shape(s) of the shutter apertures and the bundle of light being propagated by the optical system (similar to a convolution integral). Manipulating the aperture shapes directly impacts the light throughput function over time. In the exemplary embodiments described in respect of FIGS. 1A to 5C and 10A to 10C, both the shutter members and shutter apertures have been circular. Shutter members and shutter apertures may have other suitable shapes, for example as shown in FIGS. 6A to 6F.

FIG. 6A shows a generally circular shutter member 604A having a shutter aperture 614A comprising a sector-shaped gap; the gap is spaced from the center 604AC of the shutter member 60A to facilitate mounting of the circular shutter member 604A at its center 604AC. FIG. 6B shows a circular shutter member 604B having a rectangular shutter aperture 614B, FIG. 6C shows a circular shutter member 604C having a hexagonal shutter aperture 614C, and FIG. 6D shows a circular shutter member 604D having an ovoid shutter aperture 614D. FIG. 6E shows a rectangular (square) shutter member 604E having a circular shutter aperture 614E, and FIG. 6F shows a hexagonal shutter member 604F having a circular shutter aperture 614F. The centers of the shutter members 604A to 604F are denoted by references 604AC to 604FC, respectively.

Moreover, shutter members and shutter apertures within the same shutter system may have different shapes from one another.

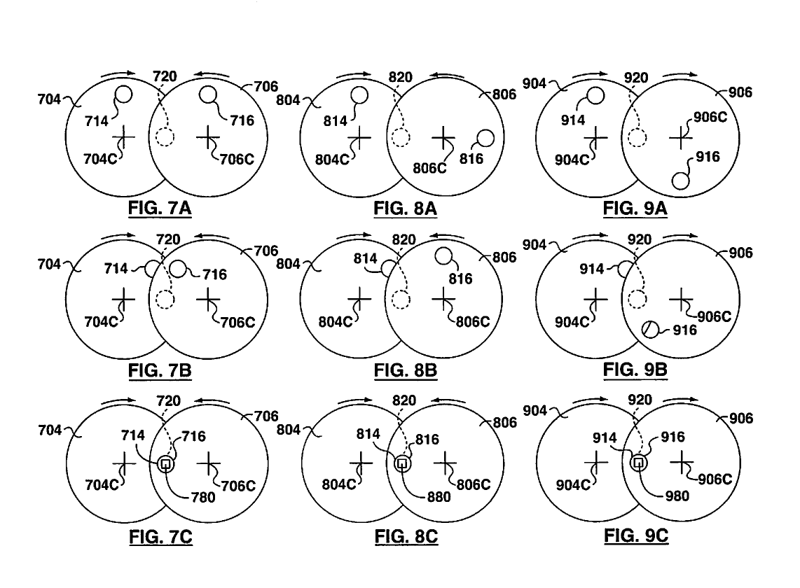

Shutter systems according to aspects of the present invention enable a method for operating an imaging device, in particular a CMOS imaging device. As shown in FIGS. 7A to 7C, 8A to 8C and 9A to 9C, according to the method overlapping first and second shutter members 704, 706, 804, 806, 904, 906 are provided having respective first and second shutter apertures 714, 716, 814, 816, 914, 916 defined therethough which orbit about the respective centers 704C, 706C, 804C, 806C, 904C, 906C as the shutter members 704, 706, 804, 806, 904, 906 are rotated. The first and second shutter members 704, 706, 804, 806, 904, 906 are rotated at different rotational frequencies so that radiation is permitted to pass through a system aperture position 720, 820, 920 to reach an image sensor 780, 880, 980 of the imaging device only when the first and second shutter apertures 714, 716, 814, 816, 914, 916 are in registration with each other at the respective system aperture position 720, 820, 920, and hence in registration with the image sensor 780, 880, 980.

The system aperture position 720, 820, 920 is defined by the position of the image sensor 780, 880, 980 of the imaging device, and hence is shown with dashed lines. Thus, in the exemplary implementations of the method shown in FIGS. 7A to 7C, 8A to 8C and 9A to 9C, radiation can pass through the system aperture position 720, 820, 920 to be received by the image sensor 780, 880, 980 only when the first and second shutter members 704, 706, 804, 806, 904, 906 are in registration with each other at the system aperture position 720, 820, 920, as shown in FIGS. 7C, 8C and 9C. The difference between the rotational frequency of the respective first shutter member 704, 804, 904 and the rotational frequency of the respective second shutter member 706, 806, 906 is selected according to a desired frame rate for the imaging device, which is referred to in sampling theory as the “beat frequency”.

The first shutter member 704, 804, 904 is shown rotating at the same rotational frequency in each of FIGS. 7A to 9C. In FIGS. 7A to 7C, the first shutter member 704 and the second shutter member 706 are rotating at the same rotational frequency. In FIGS. 8A to 8C, the second shutter member 806 is rotating twice as fast as the second shutter member 706 in FIGS. 7A to 7C, and in both cases the first shutter member 704, 804 and the second shutter member 706, 806 are rotating in opposite rotational directions. FIGS. 9A to 9C show the first shutter member 904 and the second shutter member 906 rotating in the same rotational direction but at different rotational frequencies. Where the shutter members are rotating in the same direction, they may rotate either clockwise or counterclockwise.

The length of each exposure of the image sensor will be determined by the aperture width and the rotational frequencies of the shutter members, and is given, for the case of identically sized shutter members with identical aperture widths θ, by the formula t_{frame}×θ/2π; thus the dual-shutter system enables more precise, and hence significantly shorter, exposure lengths than with a single rotating shutter (for which the length of the exposure is approximately t_{frame}×θ/π). Higher frequencies provide shorter exposures. The exposure length will be halved by rotating the shutter members in opposite directions, as shown in FIGS. 7A to 7C and 8A to 8C. For a fixed frame rate and aperture widths, there will exist a series of discrete exposure times, limited only by the ability to control the rotational frequencies of the shutter members. It will be appreciated that where both shutter members are rotated at the same rotational frequency, beginning at the same phase, or where only a single shutter member is rotated with the other shutter member stationary and its shutter aperture in registration with the system aperture position, the effect of the shutter system will be no different from a single-shutter system; thus, a shutter system according to aspects of the present invention can be selectively operated as a single shutter system as well as a dual-shutter system.

Even though the photodetectors on the focal plane array are essentially integrating all of the time, the dual-shutter system gates the incoming radiation (e.g. visible light) so that such radiation strikes the focal plane array for a shorter duration than the frame period of the imaging system. Although the gated burst of light radiation reaches each photodetector at a slightly different time, i.e. there is a slightly different relative time offset for each pixel, as long as the shutter members are rotating sufficiently quickly the data output of the image sensor will effectively represent a single point in time, i.e. a snap-shot.

Although power sources 180, 192, 280, 292, 380, 392, 480, 482, 492, 580, 582, 592, 1080, 1082, 1092 have been shown schematically as batteries, this is merely for ease of illustration; any suitable power source may be used in accordance with aspects of the present invention. Moreover, while these power sources have been illustrated as being individual power sources, this is again merely for ease of illustration, and two or more components may share a common power source.

In the Figures, the controllers 190, 290, 390, 490, 590, 1090 have been illustrated as a microprocessor unit carried by the respective support structure 102, 202, 302, 402, 502, 1002; any suitable controller, including without limitation purpose-built controllers and suitably programmed general purpose computers, may be used in accordance with aspects of the present invention. In addition, a controller need not be a separate component, but may form part of the imaging or image processing systems associated with an imaging device.

In FIGS. 1A to 1C, 2A to 2C and 5A to 5C, the phase indicators 194A, 196A, 294A, 296A, 594A, 596A are shown substantially larger than their actual size for ease of illustration. It is to be appreciated that in practical implementations, the phase indicators 194A, 196A, 294A, 296A, 594A, 596A would be much smaller than shown so as not to interfere with rotation of the respective shutter members 104, 106, 204, 206, 504, 506.

One or more currently preferred embodiments have been described by way of example. It will be apparent to persons skilled in the art that a number of variations and modifications can be made without departing from the scope of the invention as defined in the claims.

What is claimed is:

1. A shutter system for a rolling-mode integration imaging device, comprising:
a support structure;
a first shutter member rotatably mounted to the support structure so as to have a first axis of rotation;
the first shutter member having a first shutter aperture defined therethrough;
the first shutter aperture having a first circular orbit about the first axis of rotation;
a second shutter member rotatably mounted to the support structure so as to have a second axis of rotation;
the second shutter member having a second shutter aperture defined therethrough;
the second shutter aperture having a second circular orbit about the second axis of rotation;
wherein:
the first shutter member and the second shutter member at least partially overlap each other; and
the first circular orbit and the second circular orbit at least partially overlap each other so that rotation of the first shutter member and the second shutter member at different frequencies cycles the first shutter aperture and the second shutter aperture into and out of registration with each other.

2. The shutter system of claim 1, further comprising at least one actuator drivingly coupled to the first shutter member and the second shutter member to rotate the first shutter member and the second shutter member relative to the support structure.

3. The shutter system of claim 2, wherein the at least one actuator comprises a single actuator drivingly coupled to both the first shutter member and the second shutter member.

4. The shutter system of claim 2, wherein the at least one actuator comprises a first actuator drivingly coupled to the first shutter member and a second actuator drivingly coupled to the second shutter member.

5. The shutter system of claim 2, wherein the first shutter member and the second shutter member are disc-shaped shutters rotatably mounted to the support structure at their respective centers.

6. The shutter system of claim 5, wherein the first shutter aperture and the second shutter aperture are respective truncated sector-shaped gaps in the first shutter member and the second shutter member.

7. The shutter system of claim 2 wherein optically clear material extends across at least one of the first shutter aperture and the second shutter aperture.

8. The shutter system of claim 1, wherein the first axis of rotation and the second axis of rotation are co-located so that the first shutter member and the second shutter member are rotatable about a single, common axis of rotation.

9. The shutter system of claim 1, wherein the first axis of rotation and the second axis of rotation are spaced from each other.

10. A rolling-mode integration imaging system comprising:
a rolling-mode integration focal plane array;
a shutter system for a rolling-mode integration imaging device, comprising:
a support structure;
a first shutter member rotatably mounted to the support structure so as to have a first axis of rotation;
the first shutter member having a first shutter aperture defined therethrough;
the first shutter aperture having a first circular orbit about the first axis of rotation;
a second shutter member rotatably mounted to the support structure so as to have a second axis of rotation;
the second shutter member having a second shutter aperture defined therethrough;
the second shutter aperture having a second circular orbit about the second axis of rotation;
wherein:
the first shutter member and the second shutter member at least partially overlap each other; and
the first circular orbit and the second circular orbit at least partially overlap each other so that rotation of the first shutter member and the second shutter member at different frequencies cycles the first shutter aperture and the second shutter aperture into and out of registration with each other; and
comprising at least one actuator drivingly coupled to the first shutter member and the second shutter member to rotate the first shutter member and the second shutter member relative to the support structure; and
wherein the focal plane array is carried by the support structure; and
a controller coupled to the at least one actuator to control rotation of the shutter members;
so that rotation of the first shutter member and the second shutter member at different frequencies cycles the first shutter aperture and the second shutter aperture into and out of registration with each other in further registration with the focal plane array.

11. The imaging device of claim 10, wherein the focal plane array is a CMOS focal plane array.

12. A method for operating a rolling-mode integration imaging device, comprising:
rotating first and second overlapping shutter members at different rotational frequencies;
the first and second shutter members having respective first and second shutter apertures defined therethough;
so that radiation is permitted to reach an image sensor of the imaging device only when the first and second shutter apertures are in registration with each other in further registration with a focal plane array of the imaging device.

13. The method of claim 12, where a difference between the rotational frequency of the first shutter member and the rotational frequency of the second shutter member is selected according to a desired frame rate for the imaging device.
